(19) United States
(12) Patent Application Publication
(10) Pub. No.: US 2018/0072013 A1
(43) Pub. Date: Mar. 15, 2018

(54) System and Method of Preparing and Sending Greeting Cards

(71) Applicants: Wayne Rashan Taitt, Havertown, PA (US); David Michael Bullock, Staten Island, NY (US)

(72) Inventors: Wayne Rashan Taitt, Havertown, PA (US); David Michael Bullock, Staten Island, NY (US)

(21) Appl. No.: 15/629,098

(22) Filed: Jun. 21, 2017

Related U.S. Application Data
(60) Provisional application No. 62/394,972, filed on Sep. 15, 2016.

(51) Int. Cl. B31D 1/00; B42D 15/04

(52) U.S. Cl. CPC B31D 1/0075; B42D 15/042

(57) ABSTRACT

The invention includes a system for assembling greeting cards using online computer software and a printer. Personalized, affordable greeting cards can be sent using the greeting card system of the invention. The greeting card may be made with slits inside, in order to place an insert, which has personalized content selected online and printed by a user's printer and then separated and placed into each slit. Users can buy greeting cards with slits and greeting card inserts in bulk with the online system of the present invention.

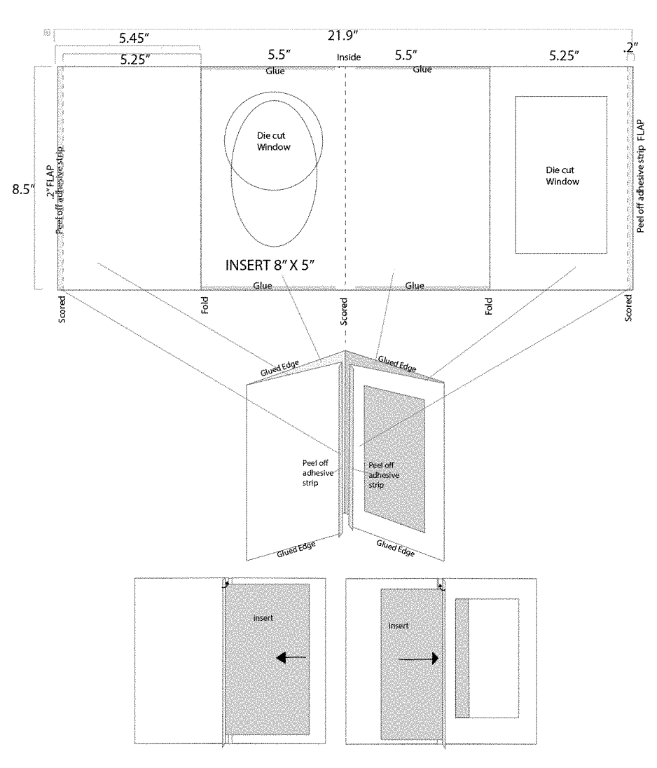

Using an online computer system, cards can be personalized with the greeting cards' verse, and for each occasion. Buying greeting cards using the described system allows the consumer to save time and money. The greeting cards with slits can come in an infinite amount of designs and be used interchangeably for different occasions. Reminders may be emailed for holidays and personal special occasions.

### BACKGROUND OF THE INVENTION

The present invention relates to a system and method of preparing and sending greetings cards.

A greeting card is an illustrated piece of card or high quality paper featuring an expression of friendship or other sentiment. Although greeting cards are usually given on special occasions such as birthdays, Christmas or other holidays, they are also sent to convey thanks or express other feelings. Greeting cards, usually packaged with an envelope, come in a variety of styles. There are both mass-produced as well as handmade versions that are distributed by hundreds of companies, large and small.

Greeting cards become expensive, time-consuming and tedious to obtain by going out to a store, which includes travel expenses, time spent sorting through the various displays and then buying the cards for each occasion.

As can be seen, there is a need for an improved system and method for sending greetings card.

### BRIEF DESCRIPTION OF THE DRAWINGS

The FIGURE illustrates an exemplary greeting card of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best de-fined by the appended claims.

The present invention includes a system for assembling greeting cards using online computer software and a printer. Personalized, affordable greeting cards can be sent using the greeting card system of the present invention. The greeting card may be made with slits inside it in order to place within an insert with a personalized verse that is selected online and printed by a user's computer printer and then placed into the slit. Users can buy greeting cards with slits and greeting card inserts in bulk with the online system of the present invention.

Using an online computer system, cards can be personalized not only with the greeting cards verse, but with each occasion. The greeting cards give more choice and personalization for the user. Buying greeting cards in bulk allows the consumer to save money. The greeting cards with slits can come in an infinite amount of designs that can be used interchangeably for different occasions. The computer system can set up reminders for holidays and personal special occasions.

Referring now to the FIGURE, the present invention may include the following process. The consumer buys from the website a bulk package of an assortment of greeting cards with slits and matching greeting card inserts. An occasion is chosen on the website, along with verse for the occasion. The insert may be placed within a printer. The selected verse from the website is then printed on the insert. The printed insert is then placed into the slit of the greeting card so that the verse inside and the occasion on the front are both showing on the greeting card. By following the process, the consumer can create a personalized greeting card, and do it over and over again efficiently, knowing that the cards are being made with great design.

An example of using the present invention may include the following. If Mother's Day is arriving in seven days, the website sends a reminder to the consumer's email, reminding that person to send a card to their mother. Using all the steps above, the person would create a card and with the proper postage send it to their mother for Mother's Day.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system and method of preparing and sending greetings cards as described above and illustrated in the FIGURE.
